(19) United States
(12) Patent Application Publication
(10) Pub. No.: US 2006/0083832 A1
(43) Pub. Date: Apr. 20, 2006

(54) Reducing acrylamide in fried food

(76) Inventor: Gregory Shannon, Boise, ID (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/233,685

(22) Filed: Sep. 23, 2005

Related U.S. Application Data
(60) Provisional application No. 60/619,577, filed on Oct. 18, 2004.

(51) Int. Cl. A23L 1/01

(52) U.S. Cl. 426/438

(57) ABSTRACT

Methods are provided for reducing the acrylamide levels in fried food. Exemplary methods include blanching potato strips in water at about 76° C. to about 88° C. for about 3 to 10 minutes. During the water blanching step, the water is circulated. The water blanched potato strips are heated with optional oil blanching at about 149° C. to about 177° C. for about 3 to 8 minutes and finally heated in oil at about 177° C. to about 190° C. for about 1 to about 5 minutes.

### CROSS-REFERENCE TO RELATED APPLICATIONS

This application claims benefit of and priority to U.S. Provisional Patent Application Ser. No. ______, filed ______, and entitled, which application is hereby incorporated by reference in its entirety.

### BACKGROUND OF THE INVENTION

1. The Field of the Invention

The present invention relates to improving the quality of fried food. More particularly, the invention relates to reducing acrylamide formation in fried food.

2. The Relevant Technology

The fried food industry has been a lucrative source of income for many restaurants world wide. French fries, potato chips, and tortilla chips are examples of popular fried food. Recently, the flied food industry has received much media attention of government officials such as health agencies, governors, and attorney generals because high acrylamide levels have been found in the fried food products. Acrylamide is a suspected carcinogen. Currently, the Food and Drug Administration (FDA) is trying to identify a “safe” range for acrylamide consumption. Presumably, the safe acrylamide consumption range will be less than what is currently found in common fried food, including french flies. Thus, it would be advantageous to reduce the amount of acrylamide in fried food. However, even if the FDA does identify a “safe” range, as will be discussed below, producers of fried food are not always ensured that their process will always result in flied products that fall within this safe range.

Using french fries as an example, french fries are typically processed in two ways: processed fries or fresh fries. The processed method includes placing cut potato strips into a water blanching phase. Usually, during the water blanching phase, sodium acid pyrophosphate, which acts as a preservative, is added to the water. The sodium acid pyrophosphate also acts as a chelator to prevent the minerals in the water from reacting with proteins in the potato strips and prevents the potato strips from turning gray.

When the potato strips exit the water blancher, they pass through a dip tank or spray bar that dips or sprays the surface of the potato strips with a high concentration of dextrose. Alternatively, the potato strips may be coated with a batter by dipping or spraying. The layer of dextrose provides a fried product (assuming manufacturer's suggested preparation steps are followed) that have a consistent color and that are not too dark or too light.

The dextrose-coated potato strips are conveyed to one or more dryers that extract internal as well as external moisture from the potato strips and then are transferred to a pre-cool area. After the pre-cool area, the potato strips are frozen. After freezing, the potato strips are dropped into a large, e.g., 12,100 liter (3200 gallon) fryer at temperatures of about 182° C. to about 185° C. (about 360° F. to about 365° F.). The potato strips are fried for a short period of time, e.g., about 44 seconds to about one minute. The fries are then recooled and frozen. Finally, the frozen fries are transferred to a grading and packaging area.

A restaurant or a domestic consumer typically purchase the processed fries and perform a final heating step. This may include frying the processed fries at about 177° C. to about 190° C. (about 350° F. to about 375° F.) for about 3 to 4 minutes. Restaurants may also place the heated french fries under a heat lamp. Health conscious consumers may prefer to bake the processed so this can typically be done at about 218° C. to 232° C. (about 425° F. to 450° F.) for about 10 minutes.

However, the processed fry steps described above result in an end product with high acrylamide levels. Tables 1 through 5 provide various acrylamide levels of test samples of about 0.91 kg (2 lb) of processed fries tested at various locations of the same restaurant chain. Furthermore, Tables 1 through 5 illustrate that acrylamide levels can vary at different locations using similarly processed fries.

TABLE 1
McDonald's ®

| Location # | Acrylamide level (ppb) |
|---|---|
| 1 | 497 |
| 2 | 328 |
| 3 | 326 |
| 4 | 245 |
| 5 | 193 |
| 6 | 155 |
| 7 | 270 |

TABLE 2
Burger King ®

| Location # | Acrylamide Level (ppb) |
|---|---|
| 1 | 369 |
| 2 | 220 |
| 3 | 197 |

TABLE 3
Kentucky Fried Chicken ®

| Location # | Acrylamide level (ppb) |
|---|---|
| 1 | 313 |
| 2 | 270 |
| 3 | 162 |
| 4 | 117 |

TABLE 4
Popeyes ®

| Location # | Acrylamide Level (ppb) |
|---|---|
| 1 | 1030 |
| 2 | 610 |
| 3 | 484 |
| 4 | 301 |

TABLE 5
Lamb Weston ® Inland Valley Fajita Fries (baked)

| Location # | Acrylamide level (ppb) |
|---|---|
| 1 | 1325 |
| 2 | 798 |
| 3 | 798 |

Processed fry manufacturing resulted from a desire by the french fry industry to be able to provide fries that are easily prepared and yet maintain a consistent color and texture. As will be appreciated from the above description, the processed fry method cannot be easily implemented at the restaurant level because it would require too many additional preparation steps. The additional preparation steps would make it extremely difficult for restaurants to provide fries in a timely manner, which could be detrimental since the ability to provide fries quickly and efficiently is critical to fast food processes and the french fry is a staple food for most fast food chains as well as other restaurants and fine dining establishments.

Furthermore, implementing a water blanching step at the restaurant level could not easily be implemented. Current water heating equipment at the restaurant level has included large kettles or pots and bain-maries which both implement manual controls which can result in inaccurate temperatures and also do not have the ability to detect and recover a temperature fluctuation. Steamers and convection ovens with steam trays operate to form steam and are not suitable for immersing blanching objects. Pasta cookers are also known in the art such as those available from Pitco Frialator, Inc., located in Concord, N.H. An example of a pasta cooker is described in Pitco Frialator® Installation, Operation, and Maintenance Manual for Gas Pasta Cookers with Options, revised May 1995, the Pitco Frialator® Service, Parts, and Schematics for Gas Pasta Cookers with Options, revised September 1995, and Picto Frialtor® Standard Specifications for Model PPG-14DL(LL), PG14D, and RS14D Gas Pasta Systems, revised August 2003, herein incorporated by reference in their entireties.

However, those of skill in the art recognize that the processed fry manufacturing process including freezing the fries, changes the taste and texture. Thus, some restaurants have opted to use the fresh fry process even though the procedure differs greatly from the processed fry methods. Conventional fresh fry processes involve a double oil fry method. Potatoes are cut into a desired cut size and then the potato strips are usually placed in cool or tepid water to prevent discoloration. The potato strips are drained of water and then cooked in oil at low temperature, e.g., about 149° C. to about 177° C. (about 300° F. to about 350° F.), for about 44 seconds to about 1 minute. The oil blanched potato strips then undergo a final heating in oil at higher temperature, e.g., 177° C. to about 190° C. (about 350° F. to about 375° F.), the length of time depending on the size of the potato strips, e.g., 2 to 3 minutes.

Tables 6 through 7 illustrate acrylamide levels of test sample of about 0.91 kg (2 lb) of fresh fries heated in various fryers. Table 6 and 7 illustrate that fresh fries also result in high acrylamide levels and that the level can vary depending on the location of the cooking. Table 6 showing fresh fries heated in different fryers according to a process substantially similar as that described above. Similarly, Table 7 shows fresh fries heated in different fryers according to a process substantially similar as that described above.

TABLE 6

| | # Fryers | | | Acrylamide |
|---|---|---|---|---|
| Location | averaged | Moisture content | % wt fat | Level (ppb) |
| 1 | 3 | 51.28 | 11.05 | 1210 |
| 2 | 4 | 52.17 | 9.98 | 976 |
| 3 | 3 | 53.16 | 11.30 | 610 |
| 4 | 4 | 49.31 | 11.58 | 598 |
| 5 | 3 | 53.46 | 9.73 | 699 |
| 6 | 4 | 54.41 | 9.04 | 515 |
| 7 | 3 | 52.72 | 8.88 | 716 |

TABLE 7

| | # Fryers | | | Acrylamide |
|---|---|---|---|---|
| Location | averaged | Moisture content | % wt fat | Level (ppb) |
| 1 | 4 | 52.84 | 11.5 | 1116 |
| 2 | 5 | 54.44 | 9.06 | 409 |
| 3 | n/a | 49.73 | 10.5 | 1227 |
| 4 | n/a | 47.74 | 11.0 | 1320 |
| 5 | n/a | 66.52 | 4.69 | 108 |
| 6 | n/a | 56.35 | 9.11 | 369 |
| 7 | n/a | 65.80 | 5.24 | 122 |
| 8 | n/a | 60.57 | 7.16 | 339 |

Furthermore, much of the scientific research being done to reduce acrylamide in fried foods are being performed at the laboratory level and do not often take into consideration practical necessities of the food service industry including the need to provide simple methods, the need to eliminate added chemicals and preservatives as well as the need to provide a consumable and appealing fried product.

### BRIEF SUMMARY OF THE INVENTION

The present invention provides novel systems and methods for producing fried food at the restaurant or consumer level. In an exemplary method, potatoes are cut to the desired shape and size. The potato strips are placed in a water blancher, immersed in water, and cooked for a period of time at a temperature of about 76° C. to about 88° C. (about 169° F. to about 190° F.). The water blanching time is about 3 to about 10 minutes, dependant on the size and shape of the potato strips. Exemplarily, for about 0.45 kg (1 lb) of 1.9 cm (¾ inch) cut potato strips, water blanching time is about 4 minutes. Following the water blanching step, the operator performs an oil blanch on the water blanched potato strips. Oil blanching can exemplary be done at about 149° C. to about 177° C. (300° F. to about 350° F.) for about 3 to about 8 minutes. A final heating is performed (even in embodiments where the oil blanching is skipped) at a temperature of about 177° C. to about 190° C. (350° F. to about 375° F.) for about 1 to 5 minutes.

Advantageously, the water blanching reduces the amount of acrylamide that forms in subsequent oil blanching and/or final heating steps. The water blanching also kills microorganisms, inactivates enzymes, gelatinizes starch cells, sets the internal/external texture, controls the color, and reduces absorption of oil in the fried food. In addition, the present methods reduce the amount of energy and resources required to prepare fried food.

The methods include additional steps that can be optionally performed to ensure that the water blancher and fryer are operating at the highest efficiency possible. These steps include 1) using an efficient fryer with sufficient energy to achieve the desired heating temperature; 2) using a digital controller that can maintain temperatures within +/−1° C. (1° F.); 3) testing the internal temperature of the flying objects; 4) performing routine fryer cleaning including boil-out solution; 5) performing periodic no load recovery tests; 6) using digital thermometer/probes to measure the temperature of the heating oil; 7) calibrating digital thermometer/probes that are used to measure the temperature of the heating medium and/or the internal temperature of the heating object; and 8) testing the frying oil (e.g., using 3-M test strips), for free fatty acid level to maintain the fryer at a safe free fatty acid level.

These and other features of the present invention will become more fully apparent from the following description and appended claims, or may be learned by the practice of the invention as set forth hereinafter.

### BRIEF DESCRIPTION OF THE DRAWINGS

To further clarify the above and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a front plan view of an exemplary water blanching system that can be used to perform the novel methods of the invention;

FIG. 2 illustrates a top plan view of the exemplary water blanching system of FIG. 1; and

FIG. 3 illustrates the user interface of a digital controller for use with the exemplary water blanching system of FIG. 1.

### DETAILED DESCRIPTION OF EXEMPLARY EMBODIMENTS

The present invention is directed to improving the quality of fried food while at the same time reducing the acrylamide level in fried food products. The systems and methods of the present invention provide an efficient and easy way for restaurants and fine dining establishments to provide high quality fried food that have a reduced acrylamide level. Part or all of the present invention may also be applied to domestic preparation of fried food.

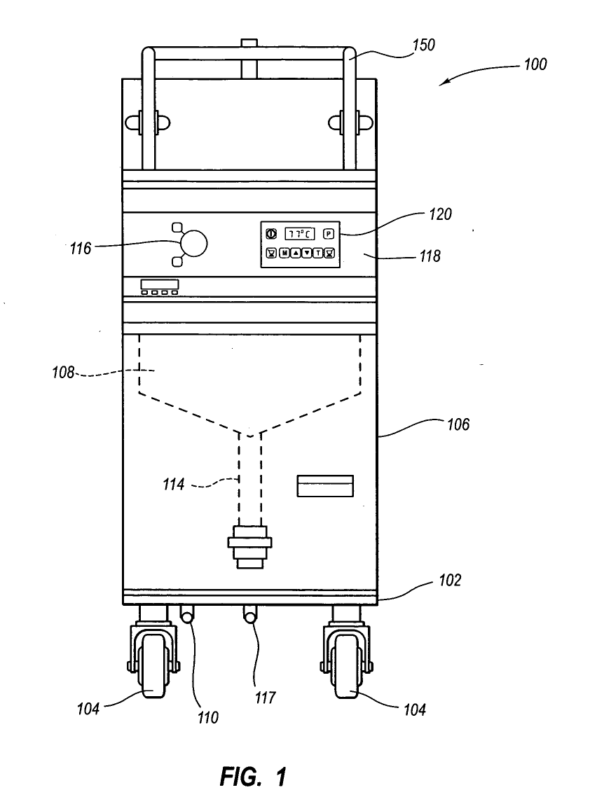

The novel methods of the present invention utilize a water blanching system to parboil high glycemic food immersed in water to remove reducing sugars therefrom. An exemplary water blanching system 100 is illustrated with respect to FIG. 1 through 3. The water blanching system 100 includes a base 102 that can be transportable using a set of wheels 104. The base 102 includes a housing 106 that houses a water blanching receptacle 108 that has enough volume to be able to blanch at least one batch of blanching objects. For example, the water blanching system has a capacity of about 45.42 liters (about 12 gallons). In one embodiment, the size of one batch of blanching objects is about 0.45 kg (about 1 lb). The size of batches of frying objects will vary depending on how quickly the water blanching receptacle can recover in temperature when blanching objects are placed in the water until recovering its specified blanching temperature. Preferably, the water blanching system is able to recover its temperature within about 15 to 30 seconds.

The water blanching system should include means for circulating fresh water in the water blanching receptacle 108. As used herein, the term “circulating” indicates systems and methods for providing an influx and outflux of water. The influx and outflux can be constant or nonconstant. Preferably, circulating includes a constant influx and outflux of water while minimizing the temperature drop in the blanching water.

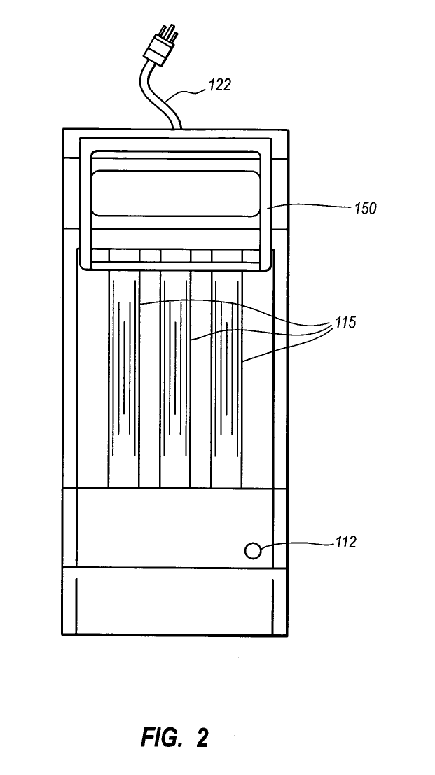

In one embodiment, the water blanching system 100 includes a water refill valve or faucet 116 that provides fresh water into the water blanching receptacle 108, water being supplied to the water refill valve 116 by a water supply hookup 117. In addition, the water blanching system can include means for draining excess water from the water blanching receptacle, which can also be part of the means for circulating fresh water in the water blanching receptacle. In one embodiment, the means for draining excess water from the water blanching receptacle can be an overflow drain 112 (FIG. 2) that removes excess water. The drain can catch overflowing water that spills over the sides of the water blanching receptacle, or, alternatively, could be an opening in the bottom of the water blanching receptacle from which to let out water by gravity and controlled by a valve. In yet another embodiment, a combination of an overflow drain 112 and bottom opening 114 in the water blanching receptacle 108 can be implemented to provide circulation of water during the water blanching process and also to drain the water from the water blanching receptacle after the water is no longer needed.

The water blanching system includes a heating means which can be any electrical or gas powered heating source that can heat water in the water blanching system to a specified temperature. In one embodiment, water blanching system 100 includes heating elements 115 (FIG. 2) that can be heated using gas or electricity. In one embodiment, a main burner system is employed, represented by reference numeral 116 which illustrates a gas supply hookup. Preferably, the water blanching system 100 includes enough energy to be able to provide for a quick recovery time. For example, in embodiments where the water blanching system 100 is heated by gas, the system may include a 81,767 KJ (77,500 BTU) main burner system.

Water blanching system 100 includes a control panel 118 that allows an operator to select the temperature at which to operate the system and also to control the refill valve 116. Selecting the temperature of the water blanching receptacle can be done in various ways such as, but not limited to, a digital controller 120 that has the capacity to maintain the water temperature at a desired temperature. In one embodiment of the invention, the digital controller 120 allows an operator to select a temperature within a desired range. Water blanching system 100 includes an electric supply 122 to provide energy to the digital controller 120. The electric supply can also provide energy to an electric heating system in embodiments that do not utilize gas power. The water blanching system 100 may also exemplarily include a bracket 150 on which to rest baskets (not shown) to hold water blanching objects.

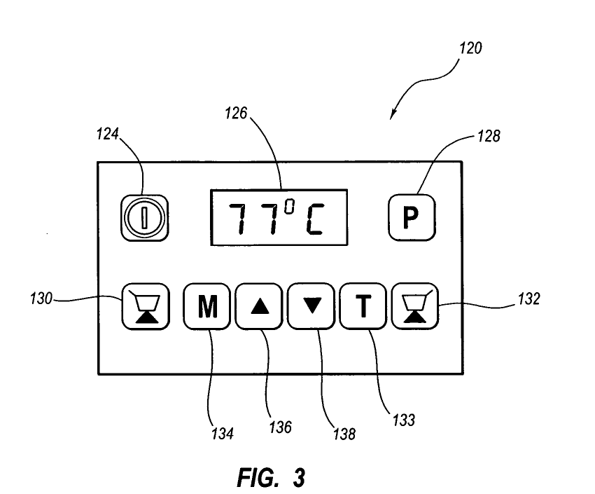

Turning to FIG. 3, an exemplary digital controller 120 is further illustrated. Digital controller 120 includes a power key 124 to turn on the water blancher system 100. The digital display 126 shows the operator at which temperature the water blanching system 100 is operating. In one embodiment, the range of temperature for water blanching potatoes provided by the digital controller 120 is about 76° C. to about 88° C. (about 169° F. to about 190° F.). Other food may have a different temperature range. However, for most foods with substantially intact cellular tissue, it is believed that a temperature range of about 76° C. to about 88° C. (about 169° F. to about 190° F.) is sufficient to provide the advantages disclosed herein.

Programming key 128 allows an operator to select between various preprogrammed options. For example, one program may be for french fries, with a first product being for regular shoestring fries and a second product being for curly fries. A second program may be for onion rings. A third program may be for potato chips. Thus, a first product key 130 may switch to preprogrammed temperature ranges for shoestring fries while the second product key 132 may use the preprogrammed temperature ranges for curly fries.

Navigation through different programs may be done using the increase key 136 or decrease key 138. Selecting a particular program key 128 or product key 130, 132 may initiate a timer that indicates termination of a predetermined time period by a loud beeping sound. The timer may be configured to correspond to the different programs 128 and/or or products 130, 132. A manual timer key 133 may be provided to allow an operator to manually set the time using the increase key 136 and a decrease key 138. A manual temperature selection key 134 may be used to allow an operator to select temperature manually using the increase key 136 and the decrease key 138. Preferably, the digital controller 120 is able to maintain the desired temperature within a variance of +/−1° C. Thus, the digital controller 120 can include an integrated circuit (not shown) to control these various functions. The integrated circuit may also include a solid state controller to maintain a selected temperature.

In other embodiments, manual controllers may be implemented that allow a user to select within a range of temperatures. A digital thermometer/probe can be used to test the temperature of the water blanching water for both digital controller and manual controller embodiments. In addition, the digital thermometer/probe can be used to test the internal temperature of the water blanching objects at various intervals to ensure that the water is indeed being maintained at a certain temperature. The thermometer/probe can also be used to measure the temperature of the oil in which the food is subsequently fried. Preferably, the digital thermometer/probe is able to register a temperature within about 10 seconds. The digital thermometer/probe can be quickly calibrated by placing the thermometer/probe in ice water for about 1 minute and determining whether the thermometer/probe registers at about 0° C. (32° F.).

Exemplary methods of the present invention include cutting a sufficient amount of potato strips to form a batch of potatoes. The weight of potatoes used in the batch size can vary due to factors described below. However, an exemplary batch size of potatoes is about 0.45 kg (about 1 lb). Potatoes can be cut using any appropriate knife or commercial cutter. Commercial cutters can exemplarily be Keen Kutters sold by Simmons Hardware Co. located in St. Louis, Mo., or Vollrath cutters sold by Windway Capital Corp. located in Sheboygan, Wis. The present invention is not limited to any particular variety of potato. However, exemplarily, a Russet Burbank potato or a Norkotah potato may be used. A Russet potato may be preferable because it has high solid content and less water which reduces cooking time. Western Russet potatoes may be preferably because they have less reducing sugars.

After cutting the potatoes, a batch of potato strips can exemplarily be placed in the water blanching system 100. Advantageously, water blanching is believed to kill any micro-organisms in the water blanching objects and to inactivate the enzymes. For potatoes, this keeps the potato strips from turning gray when the potato strips are exposed to air. While in the water blancher, the potato strips undergo diffusion in which water is driven into the potato strips so as to cause the starch cells to swell and eventually burst, releasing starch molecules to be driven out of the potato strips and into the water blanching water. The diffusion is also driven by entropy in that the heated water outside of the potato strips will release energy/heat into the cooler potato strips. This stage is called gelatinization, which causes the potato strips to have a better internal texture and crispier external texture when fried. This gelatinization also decreases fat absorption into the fry upon oil blanching or final heating. For potatoes, water blanching of potato strips also begins the cooking process and sets the external skin, resulting in a crispy exterior shell during the final heating step.

As mentioned, diffusion causes the starch cells to burst so that during water blanching of potatoes, natural reducing sugars, predominantly dextrose, are leeched out of the potato strips. Varying levels of reducing sugars can contribute to varying color in the fried product, so it is desirable to reduce the amount of reducing sugars, where possible. Potato strips having high reducing sugar content result in a much darker fried product than potato strips having less reducing sugar content. Thus, in a batch of potato strips where the potato strips have varying levels of reducing sugar, the water blanching process can reduce the high-reducing sugar content so that the all of the potato strips have a low reducing sugar level, and, thus, result in a fried product where the fries have substantially the same light golden color.

Preferably, water blanching includes circulating the water to remove as much of the reducing sugar and starches that are displaced into the water from the potato strips. Circulating water can be done on a periodic or on a continuous basis. In addition, circulation of the water causes movement in the water, which agitation can contribute to promoting release of reducing sugars and starches from the potato strips. In one embodiment, preferably all of the reducing sugars and starches that are able to be leeched out of the potato strips are removed from the water blanching water. Preferably, the rate of circulating the water is selected so that the water has a low reducing sugar concentration at all times. In one exemplary embodiment, the water blanching water is circulated at about 1 to about 5 l/min. The rate of circulating the water in the water blanching receptacle can be determined in various ways. For example, a refractometer can be used to accurately determine the Brix scale or concentration of reducing sugar, allowing an operator to adjust the rate of circulation accordingly. Alternatively, an operator can also visually assess if the circulation is sufficient by observing whether the water remains toward the end of the water blanching process. That is, the water blanching water can be circulated for a long enough period of time that the potato strips are surrounded by substantially clear water.

Preferably, the water in the water blanching system should be maintained at a temperature of about 76° C. to about 88° C. (about 169° F. to about 190° F.) during substantially the entire blanching cycle. More preferably, the water blanching system should maintain a temperature of about 77° C. to about 84° C. (about 171° F. to about 183° F.), even more preferably, from about 78° C. to about 82° C. (about 172° F. to about 180° F.), and even more preferably about 79° C. (about 174° F.) during substantially the entire water blanch cycle. The amount of water blanching objects that can be placed in the water blanching receptacle will depend on the ability of the water blanching system to maintain the desired temperature throughout the entire water blanching cycle.

Preferably, the water blanching temperature is maintained at about 76° C. or above to ensure the full benefits of water blanching described herein. It is believed that water blanching potato strips at at least about 76° C. for at least about 4 minutes inactivates enzymes and reduces bacterial count. Since the present invention does not use any preservatives or added chemicals, as a health concern, it is desirable to deactivate enzymes and reduced bacterial count before the oil blanching step, especially since water blanched potato strips can rest awhile before being oil blanched. However, it will be appreciated that a lower temperature could be used and blanched for a longer period of time while being able to sufficient inactivate enzymes and reduce bacterial count. It will also be appreciated that oil blanching or performing a final heating step in oil will inactivate enzymes by placing the enzymes in a hydrophobic environment rather than the hydrophilic environment that they are normally found. Finally, it will be appreciated that oil blanching and final heating at higher temperatures will also serve to inactivate enzymes and reduced bacterial count.

In addition, preferably, a water blanching temperature is selected at no higher than 88° C. (190° F.) as potato matter tends to break down and fall apart. However, the low temperature and the upper temperature cited herein may vary depending on the type of food being blanched as different food may decomposed at different rates. Generally, however, food with substantially intact cellular tissue and a high starch content that are typically fried for consumption tend to break apart at these cited temperatures.

The time and temperature for blanching will vary depending on the size of the potato strips. Thicker cut sizes require a longer blanch time and this can be accurately determined by using digital thermometer/probe to find out how many minutes are required for the potato strip to achieve an internal temperature that corresponds to the set temperature of the water. It will be appreciated that while a single water blanching step for a batch of frying objects is described, that a process may include more than one water blanching step for a batch of frying objects, for example, for shorter periods of time.

Following the water blanching step, the operator can perform an optional oil blanch step and/or a final heating step. Conventional fryers known in the art can be used for the oil blanching and the final heating step, such as those sold by Pitco Frialator, Inc. located in Concord, N.H. Preferably, the fryer includes a digital controller that allows the fryer to sustain the desired temperature with quick recovery should the temperature drop due to placing of cooler potato strips in the hot oil or other reasons. The fryer typically includes a heating means which can be any electrical or gas powered heating source that can heat oil in the fryer to a specified temperature. In one embodiment of the invention, the fryer should be able to maintain a temperature within a range of about 149° C. to about 188° C. (300° F. to about 370° F.). By maintaining this temperature, the frying objects will also heat up to achieve this temperature, for a substantial amount of the time that they are placed in the fryer.

Maintaining the temperature of the oil in the fryer can be done in various ways such as, but not limited to, a digital controller that has the capacity to maintain the oil temperature in the desired range. Preferably, the digital controller is able to maintain the desired temperature range within a variance of +/−1° C. (1° F.). While manual controllers can also be applied, it is desirable that a means be provided for measuring the oil temperature so that the manual controller can be adjusted accordingly should the temperature of the oil fall outside the desired temperature range. In addition, the oil or internal temperature of the potato strips can be independently monitored at various intervals to ensure that the oil is indeed being maintained at a certain temperature. In one embodiment, a digital thermometer/probe can be used to periodically check the internal temperature of the fry. The amount of food material that can be placed in the fryer will depend on how quickly a fryer can recover the temperature to sustain the desired temperature for the desired time period.

Preferably, after the water blanching step, an equilibrium step is provided in which the water blanched objects are allowed to drain for a period of time, e.g., 5 minutes, before placing the water-soaked objects directly in oil. The time and temperature for oil blanching may vary depending on the restaurant or consumer performing the oil blanching step. However, exemplarily, oil blanching can be performed at 149° C. to about 177° C. (about 300° F. to about 350° F.) for about 3 minutes to about 8 minutes. It will be appreciated that while a single oil blanching step for a batch of frying objects is described, that a process may include more than one oil blanching step for a batch of frying objects, for example, for shorter periods of time.

After the oil blanching step, an optional equilibration period may be used to allow moisture to evenly disperse through the fry. This can assist to form an even texture throughout the potato strip upon final heating. The duration of the equilibration step may vary depending on the particular implementation of the methods of the present invention. Exemplarily, an equilibration period of about ten minutes in ambient temperature is applied. If the equilibration period goes longer, it may be desirable to place the oil blanched potato strips in a refrigerated area, such as a walk-in refrigerator. The length of storing oil-blanched potato strips in ambient temperature before being required to refrigerate them may be dictated by local health codes. The equilibration period may also be useful for restaurants to prepare oil blanched potato strips in advance and then store them, for example, in a refrigeration area, until needed. Thus, draining the oil after the oil blanching step can be beneficial.

The oil blanched potato strips then undergo a final heating in oil at higher temperature at about 177° C. to about 190° C. (about 350° F. to about 375° F.) for about 1 to about 5 minutes. In one embodiment, the oil blanching step and the final heating step can occur in the same fryer. As such, it is preferable that the fryer be able to quickly heat up to the desired final heating temperature but also able to cool down to the water blanching temperature within a suitable amount of time. Alternatively, two separate fryers could be used—one to perform the oil blanching and the other to perform the final heating. It will be appreciated that while a single frying step for a batch of frying objects is described, that a process may include more than one frying step for a batch of frying objects, for example, for shorter periods of time.

In another embodiment, the operator may proceed directly to the final heating step with the water blanched objects, eliminating the oil blanching step. For example, water blanched objects can be sent directly for final heating at about e.g., 177° C. to about 190° C. (about 350° F. to about 375° F.) for about 4 minutes to about 8 minutes.

It will be appreciated that the temperatures of the water blanching, oil blanching and final heating mediums will change as objects are placed in the water or oil and that temperatures may fluctuate during the process. However, preferably the digital controllers in the water blanching system, oil blanching system and/or final heating system are able to sustain the desired temperature for substantially the entire processing time. During the oil blanching or the final heating steps, if the temperature drops significantly from the desired temperature, then that is an indication that the fryer likely needs maintenance or temperature adjustments.

Exemplary water blanching, oil blanching, and/or final heating times are describe in the following examples:

### EXAMPLE 1

A basket of 0.45 kg (1 lb) potato strips with 0.64 cm (¼ inch) cut size was water blanched using the following parameters.

| | | | Equilibration |
|---|---|---|---|
| | Time | Temperature | Time |
| Water Blanching | 5 minutes | 80° C. (175° F.) | At least 5 |
| | | | minutes |
| Oil Blanching | 4 minutes | 168° C. (335° F.) | At least 30 |
| | | | minutes |
| Finished Fry | 2 minutes | 182° C. (360° F.) | — |

### EXAMPLE 2

A basket of 0.45 kg (1 lb) potato strips with 0.95 cm (⅜ inch) cut size was prepared using the following parameters.

| | | | Equilibration |
|---|---|---|---|
| | Time | Temperature | Time |
| Water Blanching | 5 minutes | 79° C. (175° F.) | At least 5 |
| | | | minutes |
| Oil Blanching | 4 minutes | 168° C. (335° F.) | At least 30 |
| | | | minutes |
| Finished Fry | 2 minutes | 182° C. (360° F.) | — |

### EXAMPLE 3

A basket of 0.45 kg (1 lb) potato strips with 1.27 cm (½ inch) cut size was prepared using the following parameters.

| | | | Equilibration |
|---|---|---|---|
| | Time | Temperature | Time |
| Water Blanching | 8 minutes | 88° C. (190° F.) | At least 5 |
| | | | minutes |
| Oil Blanching | 6 minutes | 168° C. (335° F.) | At least 30 |
| | | | minutes |
| Finished Fry | 2.5 minutes | 182° C. (360° F.) | — |

### EXAMPLE 4

A basket of 0.45 kg (1 lb) potato strips with wedge cut size was prepared using the following parameters.

| | | | Equilibration |
|---|---|---|---|
| | Time | Temperature | Time |
| Water Blanching | 10 minutes | 88° C. (190° F.) | At least 5 |
| | | | minutes |
| Oil Blanching | 8 minutes | 168° C. (335° F.) | At least 30 |
| | | | minutes |
| Finished Fry | 4.5 minutes | 182° C. (360° F.) | — |

TABLE 8

| | | | % reduction |
|---|---|---|---|
| Fryer | % wt fat | Acrylamide Level (ppb) | of acrylamide |
| Prior Art | 4.69 | 108 | — |
| Example 1 | 3.48 | 18 | 83.33% |
| Example 2 | 2.58 | 10 | 90.74% |

Using either the water blanching/oil blanching/frying process or the water blanching/frying process, after the fried product has sufficiently cooled, flavorings or seasonings containing reducing sugars can be applied to the exterior of the fried product without increasing the risk of forming acrylamide. The flavoring or seasonings preferably are low in acrylamide.

Advantageously, using either the water blanching/oil blanching/frying process or the water blanching/frying process, the resulting fried product will have less acrylamide than conventional processed fried products or fresh fry products. Table 8 illustrates that even when compared to the best case scenario of the conventionally formed fresh fries described in the Background Section, the present invention experiences 83.33% to 90.74% reduction in the acrylamide level in the resulting fried product.

The present invention also includes other features which can assist in reducing the level of acrylamide formation in fried products. In one embodiment, the selection of the potato can affect the acrylamide level. As discussed above, one aspect of the present invention is extracting as much of the reducing sugar from the raw potato product as possible. The amount of reducing sugars in potatoes increases as the growing season progresses. Potato growers typically rate a harvested batch of potatoes before storing which typically correlates with the time of season in which the potato is harvested. For example, a potato may be rated according to the USDA Munsell color chart, a lower rating (e.g., between 0 and 2) indicating lower reducing sugars while a higher rating (e.g., 4) indicates higher reducing sugars.

In late August or early September, potatoes have very little natural reducing sugars. When a fresh potato harvested in early Fall is fried at high temperature, e.g., 177° C. (350° F.) or above, the resulting fried product is a golden brown color. As the growing season progresses and the ground cools, the lower temperature converts the starch into reducing sugars. When these later-harvested potatoes are fried at high temperatures, the fried product has a dark color because of the reducing sugars and can also have an undesirable burnt or bitter taste.

In addition, while most packing sheds are very careful to store potatoes at 13° C. to 18° C. (about 55° F. to about 65° F.) and at 98% humidity to prevent the potatoes from rotting, during transportation between various distribution centers, the harvested potatoes are sometimes mixed or stored with food that require a lower refrigeration temperature. Thus, this can expose these harvested potatoes to lower temperatures, converting the starch to reducing sugar. Furthermore, since some of these potatoes are stored for long periods of time (e.g., eight to ten months), sprout inhibitors and refrigeration are often used to prevent the potatoes from sprouting.

Ideally, restaurants can buy a certain rated potato that was harvested towards the beginning of the potato season to increase the likelihood of having potatoes with low reducing sugars which will produce a lighter golden fry. However, lower sugar-rated potatoes are generally more expensive. Furthermore, restaurateurs are not always assured of the rating of the potato that is received from their suppliers. Between packing and supplying, the chemical constitution of the potato can change, thus changing the actual rating of the potatoes that are eventually fried without the restaurateur's knowledge.

For those restaurants or consumers who opt for the fresh fry process, conventional fresh frying processes illustrate that no thought is given as to how to ensure that the potatoes have as little reducing sugars as possible before frying. Advantageously, the present invention provides a method by which the restaurant owner can reduce the level of reducing sugars in the potato strips before frying. This is possible because the water blanching leeches out reducing sugars. Thus, even if different pieces of potato strips (e.g., from different potatoes) have different initial levels of reducing sugars, by leeching out as much reducing sugars as possible, the potato strips that are water blanched according to the teachings of the present invention will all have low reducing sugar levels, increasing the likelihood that the fries will cook to the same golden color.

However, a restaurateur could increase the likelihood of having low reducing sugar level potatoes by buying a certain rating of potato. Assuming the rating remains substantially the same when delivered to the restaurateur, when such a rated potato is combined with the present invention, it will be appreciated that the acrylamide levels produced in resulting fresh fries will be quite low.

Additional factors that can relate to minimizing the likelihood of formation of acrylamide in fried food relate to the operation of the fryer. Tables 1 through 7 in the Background Section illustrate that acrylamide levels can vary using the same type of processed or fresh fry, depending on the particular location at which the final french fry is cooked. This is evidence that the frying process may actually contribute to the formation of acrylamide in the fried product even though all of the preceding french fry processing steps are performed substantially the same.

Some factors that play into fryer inefficiencies include 1) using new or older fryers without enough energy, which results in insufficient heat to cook fries; 2) using manual controllers that have +/−5° C. to 10° C. (+/−10° F. to 20° F.) variation in temperature, which results in a possibility of cooking at higher or lower temperature than believed; 3) failure to test internal cooking temperatures of the fries, which results in the possibility of cooking at higher or lower temperature than believed; 4) failure to have a routine fryer cleaning procedure with boil-out solution, which results in excess carbon insulating the fryer (reducing frying efficiency); and 5) failure to perform a no load recovery test to check gas pressure which drives fryer recovery between frying processes [e.g., once every 6 months]. Inadequate results in each of these factors generally results in the operator increasing the temperature of the frying in order to compensate for the negative affects of these of these factors. As a result, the operator is increasing the likelihood of acrylamide formation in the fried food, since acrylamide is more likely to form at higher temperatures, e.g., over 177° C. (350° F.).

Thus, proper fryer maintenance can play a role in reducing the formation of acrylamide in fried food. Even where fresh potato strips have first been blanched, frying at higher temperatures increases the likelihood that more of the reducing sugars that are still left in the potato strip are converted to acrylamide. However, it will be appreciated that using the above water blanching/oil blanching/final heating or water blanching/final heating steps even with a fryer that perhaps is not working at optimal efficiency can still reduced acrylamide level in fried products even lower than conventional fresh fry processes. Furthermore, when combined with an optimally efficient fryer, the present invention can result in fried products with extremely reduced acrylamide levels.

Another disadvantageous by-product of heating food at excessively high temperatures is the degradation of the cooking oil. For every 5° C. (10° F.) above 177° C. (350° F.), the oil degradation doubles and raises the free fatty acid level in the cooking oil. This oil ultimately begins to foam and turn dark, which, in turn, affects the food fried in the degraded oil. Generally, such food are not healthy for public consumption.

Thus, in order to optimize the fresh fry process disclosed herein, additional process steps can include 1) using an efficient fryer with sufficient energy to achieve the desired heating temperature; 2) using a digital controller that can maintain temperatures within +/−1° C. (1° F.); 3) testing the internal temperature of the frying objects; 4) performing routine fryer cleaning including boil-out solution; and 5) performing periodic no load recovery tests. Additional process steps can include 6) using digital thermometer/probes to measure the temperature of the heating oil; and 7) calibrating digital thermometer/probes that are used to measure the temperature of the heating oil and/or the internal temperature of the heating object. Finally, an additional process step relates to 8) testing the frying oil (e.g., using 3-M test strips), for free fatty acid level to maintain the fryer at a safe free fatty acid level. Furthermore, it will be appreciated that such fryer maintenance and calibration steps would add only minimal additional steps to the fresh fry methods disclosed herein.

In summary, among other things, the present invention provides means for consistently controlling and lowering the acrylamide level to assist restaurants, fine dining establishments, and other consumers to reduce the threat of acrylamide in their fried food. The novel fresh fry methods implementing an initial water blanching step extracts as much reducing sugar and starch as possible before frying. Because different batches of potatoes may have been harvested at different times during the year and stored in different environments until they are shipped to a restaurant or a store, a consumer is not ensured that the reducing sugar content of the potatoes will be consistent from batch to batch. Thus, by water blanching the potato before heating in oil, as much starch and reducing sugars as possible are removed from potato strips. Combined with circulating the water blanching water to remove the extracted reducing sugars and starches, this results in only a minimal amount of reducing sugar remaining in each batch of water blanched potato strips so that the potato strips will result in substantially the same golden color.

Because the water blanching begins to cook the raw potato, this shortens the fry times and conserves on energy, both gas and electricity. As a result of the water blanching gelatinizing the starch cells, this greatly reduces oil absorption into the fry and conserves the amount of cooking oil needed for frying which results in reducing costs to the restaurant operator and/or consumer. Because this reduces the percentage of fat absorbed into the french fry, this results in less calories. Further, since there has been a tremendous escalation of gas prices, restaurants have seen a rise in the costs of raw, as well as, frozen potato products and cooking oil. Thus, the present invention serves to reduce costs in restaurant operating costs.

Furthermore, the present invention provides methods that are simple to implement. Because of the nature of both fast food and fine dining restaurants, it is preferable that procedures implemented in these types of environment be simple and easily learned and implemented by the average employee.

Additionally, the present invention improves the quality of the fried product by reducing bitter-tasting reducing sugar by-products, improving the texture and crispiness of the exterior shell of the fried food, improving the interior texture of the shell, distributing the moisture content of the interior of the food to result in a light, “fluffy” texture, as well as decreasing the fat absorption of oil into the fried food, which results in a more natural taste and less calories. In addition, the natural taste of the french fry is enhanced because the present method uses no added preservatives, chelating compounds, pH altering compounds, or other chemicals. The present invention thus results in fried products that are extremely environmentally compatible and biodegradable.

Restaurants can prep the fries by performing the water blanching and oil blanching steps and then storing the oil blanched potato strips until the final heating step. Traditionally, restaurants have prepped the potato strips by soaking them into water before undergoing the oil blanching or final heating step. Thus the present invention can eliminate the need to store the potato strips in water before sending directly to the oil heating phase. Where water-stored potato strips have previously taken more than a few bins to hold enough fries to satisfy customer demand for a period of time, it will be appreciated that water can be conserved and shelf space in refrigeration areas can be greatly minimized by only having to store oil blanched potato strips. Note, however, that in the present invention, the operator may optionally store freshly cut potatoes in water before performing the water blanching step.

All of these advantages are provided while additionally providing a simple, efficient and economical way of satisfying state and health agencies' requirements to prepare fried food with significantly lower acrylamide levels.

While the present invention has been described using handling and processing potatoes for fries, teachings of the present invention can extend to other fried food such as, but not limited to, curly fries, criss-cut fries, hash browns, potato skins, potato chips, tortilla chips, flied onion products, sweet potato products, and other grains (e.g., wheat, oat, rye, corn and rice), nuts, and other fruits and/or vegetables, and the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for making a batch of fresh fries at a restaurant, the method comprising:
blanching a batch of potato strips by submersing the potato strips in water and cooking at a temperature of about 76° C. to about 88° C.;
circulating the water until the water is substantially clear; and
final heating the batch of potato strips in oil at a temperature of about 177° C. to about 190° C. until the fries have a golden exterior.

2. The method as recited in claim 1, further comprising performing the water blanching step at a temperature range of about 77° C. to about 84° C.

3. The method as recited in claim 1, further comprising performing the water blanching step at a temperature range of about 78° C. to about 82° C.

4. The method as recited in claim 1, further comprising performing the water blanching step at a temperature range of about 79° C.

5. The method as recited in claim 1, further comprising equilibrating the batch of water blanched potato strips after water blanching.

6. The method as recited in claim 5, wherein equilibrating the batch of water blanched potato strips is performed for at least 15 minutes.

7. The method as recited in claim 1, further comprising blanching the batch of water blanched potato strips in oil at a temperature of about 149° C. to about 177° C. before final heating.

8. The method as recited in 7, further comprising equilibrating the batch of oil blanched potato strips after blanching in oil.

9. The method as recited in claim 8, wherein equilibrating the batch of oil blanched potato strips is performed for at least 15 minutes.

10. The method as recited in claim 1, further comprising monitoring the temperature of the water with a digital thermometer.

11. The method as recited in claim 1, further comprising maintaining the internal temperature of the batch of potato strips within a temperature of about 76° C. to about 88° C. for substantially the entire blanching time in water.

12. The method as recited in claim 11, further comprising monitoring during the blanching in water the internal temperature of at least one of the potato strips of the batch of potato strips with a digital probe to determine whether the internal temperature is within a temperature of about 76° C. to about 88° C.

13. The method as recited in claim 1, further comprising monitoring the temperature of the oil with a digital thermometer.

14. The method as recited in claim 1, further comprising using an efficient fryer with sufficient energy to achieve the desired heating temperature.

15. The method as recited in claim 1, further comprising using digital controllers that can maintain temperature of the water and the oil within +/−1° C. (1° F.)

16. The method as recited in claim 1, further comprising performing routine fryer cleaning including boil-out solution.

17. The method as recited in claim 1, further comprising performing periodic no load recovery tests.

18. The method as recited in claim 1, further comprising testing a free fatty acid level of the oil for final heating.

19. The method as recited in claim 1, further comprising monitoring the levels of starch and reducing sugars in the water using a refractometer.

20. The method as recited in claim 1, further comprising cutting an amount of potatoes having a low reducing sugar rating to make up a batch of potato strips.

21. The method as recited in claim 1, wherein circulating the water comprises a constant influx and outflux of water at a rate that minimizes the drop of temperature in the water.

22. The method as recited in claim 1, wherein circulating the water comprises a non constant influx and outflux of water at a rate that minimizes the drop of temperature in the water.
